(19) United States
(12) Patent Application Publication
(10) Pub. No.: US 2010/0133354 A1
(43) Pub. Date: Jun. 3, 2010

(54) FOG GENERATOR

(75) Inventor: Alfons Vandoninck, Opglabbeck (BE)

Correspondence Address: DARBY & DARBY P.C., P.O. BOX 770, Church Street Station, New York, NY, 10008-0770, US

(73) Assignee: BANDIT NV, Opglabbeck (BE)

(21) Appl. No.: 12/596,036

(22) PCT Filed: Apr. 23, 2008
(86) PCT No.: PCT/EP08/54931

§ 371 Date: Dec. 4, 2009

(30) Foreign Application Priority Data
Apr. 27, 2007 (EP) 07008601.2

(51) Int. Cl. A01G 15/00; B05C 1/00

(52) U.S. Cl. 239/14.1; 239/136

(57) ABSTRACT

The present invention is directed to a fog generator comprising a vessel that contains a fog generating fluid and a compressed propellant gas for driving the fog generating fluid from the vessel into a heat exchanger which transforms the fog generating fluid into steam and is connected with the vessel, and a valve positioned between the vessel and the heat exchanger, characterized in that the valve is adapted for controlling the fog generating fluid flow rate by varying its orifice resistance as a function of vessel pressure, such that the fluid flow rate is independent of vessel pressure.

### FIELD OF THE INVENTION

The present invention relates to a device for generating fog.

### BACKGROUND OF THE INVENTION

Fog generators are used in a variety of applications. They can be used in applications concerning security, e.g. for generating a fog screen by which goods or valuables are screened out from the intruder's sight, or for simulating fire as a training aid for emergency services or security forces. They can also be used in applications concerning entertainment, e.g. for creating lighting effects on stage, etc.

According to the state of the art, a main working principle of a fog generator is as follows: a fog generating fluid is driven into a heat exchanger by a pump; in the heat exchanger, the fog generating fluid is heated and transformed into fog generating fluid steam; at the end of the heat exchanger, the steam is ejected then in the form of a fog into the ambient.

However, in particular for security applications pumps usually do not generate enough capacity at sufficient pressure to eject the fog with a desired ejection capacity at sufficient pressure. Propellant gasses however generate much higher capacity at sufficient pressure. In EP1402225, a fog generator is described having a vessel containing the fog generating fluid and a liquified propellant gas to drive the fog generating fluid into the heat exchanger. As liquified propellant gas, gases from the group of partly halogenated hydrocarbons, or so called HFC gases are used because of their low toxic, low inflammable properties. However, due to severe legal restrictions on the use of these greenhouse gases, a fog generator having an alternative way to drive the fog generating fluid into the heat exchanger would be preferred.

An alternative to the use of liquefied propellant gas is described in GB-A-1 039 729 wherein the fog generating fluid is driven to the heat exchanger by means of compressed carbon dioxide propellant gas. A valve switches on and off the compressed propellant gas flow to force the fog generating fluid into the heat exchanger. A severe drawback is that the fog generating fluid is exposed to decreasing pressure, since the compressed propellant gas volume decreases during fog generation, and the fog fluid flow rate will decrease accordingly.

In U.S. Pat. No. 5,803,359, a glycol mixture is driven into the heat exchanger without using a pump or pressure vessel. The mixture itself generates constant vapor pressure by keeping it at certain temperatures such that it is driven into the heat exchanger.

It is clear there remains a need for a fog generator which is less energy consuming and ejects the fog with a desired force and volume, while being environmentally acceptable.

Further, it is very important to keep the mixture of fog generating liquid and steam passing through the heat exchanger at a temperature within a dedicated range dependent of used fog generating fluid composition. In many cases, this range is from about 240° C. to about 280° C. If the temperature is too low (below 220° C.), the resulting fog will have a big droplet size and will tend to condensate too easily, which is not desirable. If the temperature is too high (above 300° C.), high risk for oxidation of the glycol components in the fog generating fluid is present, resulting in exhaust of toxic substances like aldehydes and in particular formaldehyde and acetaldehyde. However, in conventional fog generators a heat exchanger capacity is variable, because its temperature decreases fast due the thermal energy consumption by heating and transforming the fog generating fluid into steam. Consequently, at a constant flow rate the temperature of the mixture of fog generating liquid and steam inside the heat exchanger and the temperature of the ejected fog is also variable.

A fog generator to alleviate the above problem is proposed in U.S. Pat. No. 4,764,660. A temperature controller is selected or designed to maintain the temperature of the resistance heater coil at the appropriate level to superheat the fog generating fluid regardless of the fluid flow rate.

Further, in U.S. Pat. No. 4,818,843 a smoke generator comprising a coiled electrical resistance heating tube with one end connected to a pump and the other end functions as smoke outlet. A pair of thermostats mounted on the heating tube senses the temperature and actuates the pump for pumping fog fluid form the reservoir into the tube.

Also in GB2315683, control means are provided to ensure that the heating element runs at a substantially constant temperature. This however is very energy consuming at fog generating capacity desired for security applications. Particularly in security applications, where it is important to generate as much fog as possible in as less time as possible and usually at unpredictable moments in time, not enough electrical power (between 15 en 50 KWatt) is available.

As indicated above, a preferred fog generator would have more fog ejection performance, and would be able to keep the ejected fog temperature within an appropriate range.

In contrast to prior art fog generators, a fog generator in accordance with the present invention is less energy consuming, environmentally acceptable and able to eject the fog with a high ejection capacity at sufficient pressure, while the ejected fog temperature is kept within its desired temperature range.

### SUMMARY OF THE INVENTION

The present invention is directed to a fog generator comprising a vessel that contains a fog generating fluid and a compressed propellant gas for driving the fog generating fluid from the vessel into a heat exchanger which transforms the fog generating fluid into steam and is connected with the vessel, and a valve positioned between the vessel and the heat exchanger, characterized in that the valve is adapted for controlling the fog generating fluid flow rate by varying its orifice resistance as a function of vessel pressure, such that the fluid flow rate is independent of vessel pressure.

### BRIEF DESCRIPTION OF THE DRAWINGS

FIG. 1 shows an embodiment of a fog generator in accordance with the present invention.

FIG. 2 shows a preferred embodiment of a fog generator in accordance with the present invention.

### DESCRIPTION OF THE INVENTION

A person skilled in the art will understood that the embodiments described below are merely illustrative in accordance with the present invention and not limiting the intended scope of the invention. Other embodiments may also be considered.

The present invention provides a fog generator comprising a vessel that contains a fog generating fluid and a compressed propellant gas for driving the fog generating fluid from the vessel into a heat exchanger which transforms the fog generating fluid into steam and is connected with the vessel, and a valve positioned between the vessel and the heat exchanger, characterized in that the valve is adapted for controlling the fog generating fluid flow rate by varying its orifice resistance as a function of vessel pressure, such that the fluid flow rate is independent of vessel pressure.

As explained above, in prior art HFC gases are used as liquified propellant gas to drive the fog generating fluid from the vessel into the heat exchanger, because they are not toxic and have vapor pressures of for example 15 bars at 30° C. for R125. At these pressures and under constant temperature, they maintain equilibrium between their gas phase and liquid phase and keep the pressure in the vessel constant. Consequently, the fog generating fluid is driven from the vessel into the heat exchanger under constant pressure and therefore at constant flow rate, independent of the amount of fog generating fluid left in the vessel.

However, when using compressed propellant gasses instead of liquified propellant gasses, the vessel pressure is dependent on the gas-liquid ratio in the vessel, thus on the volume of fog generating fluid left in the vessel. Consequently, the fog generating fluid is exposed to decreasing pressure when its volume decreases and its flow rate will decrease accordingly. For example, a gas volume of 0.45 liter at 110 bars in a vessel of 1.5 liter will expand to 1.5 liter gas at about 33 bars while the fog generating fluid volume decreased from 1.05 liter to complete consumption.

When installing a valve adapted for controlling the fog generating fluid flow rate between the vessel and the heat exchanger, the amount of fog generating fluid entering into the heat exchanger per unit time may be controlled. When the fog generator is in non-active state, this valve closes the vessel hermetically. When the fog generator is in active state, the orifice resistance of the valve may be varied to control the fog generating fluid flow rate, i.e. the amount of passed fog generating fluid per time unit, and to deliver a determined amount of fog generating fluid towards the heat exchanger.

In an embodiment of the present invention, the fog generating fluid flow rate may be controlled independently of vessel pressure. By changing the orifice resistance of the valve as a function of vessel pressure, the fog generating fluid flow rate may be kept substantially constant, independently of vessel pressure.

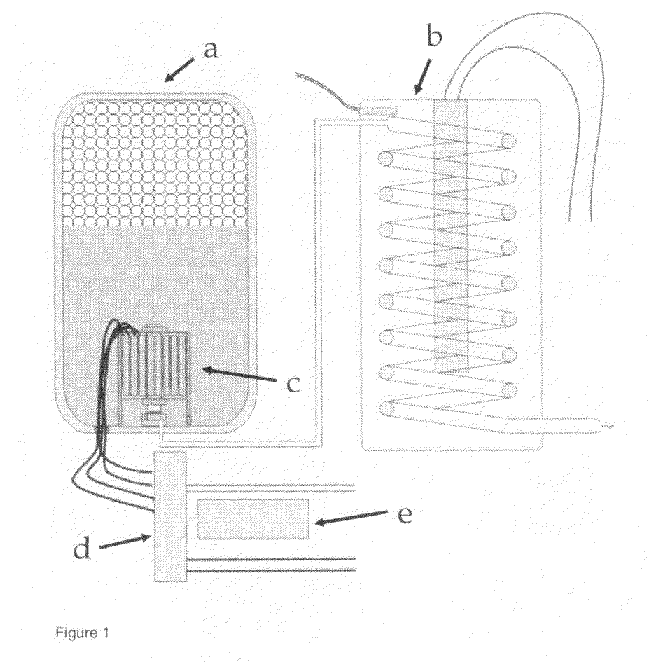

The vessel pressure may be determined by measuring it with a pressure sensor. The pressure value may then be transmitted to a valve controller which will control the orifice size as a function of vessel pressure. The vessel pressure may also be calculated as a function of consumed amount of fog generating fluid and compressed propellant gas dissolved in the fog generating fluid. The calculated pressure values may be stored in a memory and further transmitted to the valve controller. In FIG. 1, a fog generator is shown comprising a pressure vessel (a), a heat exchanger (b), a valve for controlling the fog generating fluid flow rate (c), a valve controller (d) and a pressure value memory (e).

In another embodiment of the invention, the fog generating fluid flow rate may be controlled as a function of expelling fog temperature. The temperature values may be measured by any means for measuring the temperature of the expelling fog, such as but not limited to a temperature sensor positioned such that it is able to measure the temperature of the expelling fog at the end of the heat exchanger channel(s). These temperature values may be transmitted to the valve controller which will control then the fog generating fluid flow rate as a function of expelling fog temperature.

In particular with respect to fog generators for security applications, one seeks to generate as much fog as possible in as less time as possible to eject the fog as fast as possible in a space to be protected. As explained above, the heat exchanger temperature decreases fast due to the thermal energy consumption by heating and transforming the fog generating fluid into steam. Consequently, during the first time period of fog generation, the fog generating fluid flow rate from the vessel into the heat exchanger may occur at a higher rate, because the heat exchanger's heating capacity is the highest during that time period. The fluid flow rate may decrease proportional as a function of decreasing heat exchanger heating capacity. Optimizing the fog generating fluid flow rate as a function of fog temperature could make it possible to eject the fog at temperatures within a preferred range.

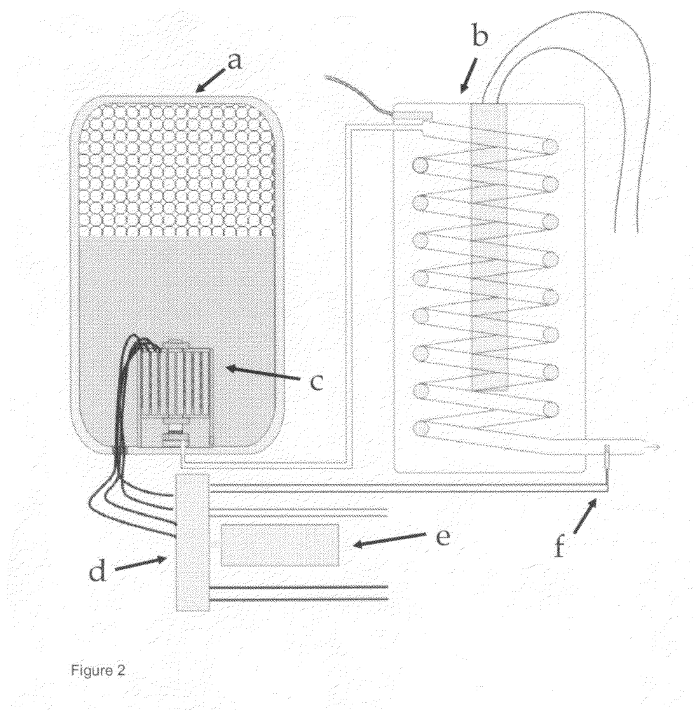

In a preferred embodiment, the fog generating fluid flow rate control as a function of fog temperature may be used as a fine-tuning additionally to the flow rate control independently of vessel pressure. In FIG. 2, a fog generator is shown comprising a pressure vessel (a), a heat exchanger (b), a valve for controlling the fog generating fluid flow rate (c), a valve controller (d), a pressure value memory (e), and a fog temperature sensor (f).

In particular with respect to fog generators in security applications, fog generating fluid flow rate control, independently of vessel pressure and additionally as a function of expelling fog temperature, is advantageous in terms of generated fog volume per time unit, because the heat exchanger's capacity can be used in an optimal way.

The propellant gas may be any low toxic, low inflammable and environmentally acceptable compressed gas, e.g. between 20 and 130 bar. Preferably, it may be an inert gas, such as but not limited to nitrogen, or a noble gas, such as but not limited to helium, neon, or argon. It may also be a mixture of noble gasses or a mixture of inert and noble gasses, such as but not limited to a mixture of argon and nitrogen.

An advantage of working with compressed propellant gasses at high pressures is that, due to the high pressure difference between the pressure vessel and the atmospheric ambient at the end of the heat exchanger, the compressed gasses are released inside the heat exchanger, thereby generating turbulence, which results in increased thermal contact and easily transforming the fog generating fluid into steam inside the heat exchanger.

Further, the high pressure difference between the pressure vessel and the atmospheric ambient at the end of the heat exchanger results in a so-called break-up effect, i.e. a fluid droplet saturated with dissolved gas at high pressure will break up into smaller droplets, when leaving the high pressure ambient and entering a low pressure ambient. The break-up effect is explained both by suddenly increasing size of dissolved gas bubbles when suddenly entering a decreased pressure ambient, and by dissolved gas escaping from the fog generating fluid due to lower solubility of the gas at lower pressure. Therefore it is preferable that the compressed propellant gas dissolves well in the fog generating fluid at used fog generator vessel pressures.

Further, the heat exchanging capacity of a heat exchanger is mainly determined by the total inside surface of its heating channel or channels, the mean temperature of this surface and the contact intensity between the fog generating fluid and the channel surface. Foaming up and chaotic turbulence in the channel enhances this contact intensity and thus the heat transfer to the fog generating fluid. In prior art, foaming and chaotic turbulence is achieved by adding an amount of water to the fog generating fluid, typically between about 10 and about 50 volume percent, by which very turbulent steam generation occurs. However, an important disadvantage of using water is its large specific heat and heat of evaporation and consequently large energy consumption. By using compressed propellant gasses as proposed in the context of the present invention, the amount of gas entering together with the fog generating fluid in the heat exchanger is substantial due to the large amount of gas being solved in the fog fluid at high pressure. Inside the heat exchanger channel(s), the dissolved gas escapes violently from the fog generating fluid, further resulting in foaming and chaotic turbulence without the need to use high percentages of water, preferably about 10 volume percent to assure the fog being non-inflammable.

The valve adapted to control the fog generating fluid flow rate may be any valve suitable for controlling a fluid flow rate, such as but not limited to an electromagnetic valve, a disc valve, or a ball valve. Preferably a disc valve is used, even more preferably a ceramic disc valve, because a ceramic disc valve is much qualified for operating under high pressure conditions and because it is not liable to dirt.

The valve may be an electromagnetic normally closed (NC) valve, which will switch between open and closed state with a frequency determined by a valve controller with Pulse Width Modulation (PWM). By varying the open-closed ratio, the mean fog generating fluid flow rate and the amount of passed fog generating fluid can be controlled. This open-close switch frequency may be between 1 and 80 Hz, between 1 and 40, and preferably 8 Hz.

The valve may be a disc valve driven by a motor with a controller which determines the position of the moveable disc with respect to the fixed disc. The moveable disc contains an opening or openings with fixed diameter. By rotating the moveable disc in a certain position with respect to the fixed disc, the size of the valve opening and the fog generating fluid flow rate is determined. The motor may be a stepper motor or a position controlled servo-motor.

The valve may be a ball valve, which is also driven by a motor with controller which determines the position of the ball in the valve housing. The ball is perforated and can be rotated in the valve housing containing an inlet and outlet opening. The rotational position of the ball and its perforation with respect to the inlet and outlet of the housing determines the size of the valve opening and the fog generating fluid flow rate.

A disc valve or ball valve may be advantageous as compared to an electromagnetic valve in that sense that they need less electrical power to control the valve orifice at high counter pressures.

In accordance with the present invention, the fog generating fluid may comprise at least one glycol or at least one glycerol. Mixtures comprising a glycol and a glycerol, or two or more glycols, or two or more glycerols may be used. To optimize the quality of the fog, the fog generating mixture preferably contains approximately about 5 to 25 volume percent of water, and about 50 to about 80 volume percent of glycol. The glycol may be a mixture of about 10 to 25 volume percent of triethylene glycol, the remainder being dipropylene glycol, but other glycols and glycol mixtures may also be used. An example of a very suitable fog generating fluid comprises about 10 volume percent of water, about 10 volume percent of triethylene glycol, and about 80 volume percent of dipropylene glycol.

Below an operating cycle of a fog generator in accordance with the present invention is described.

In stand-by mode, the fog generator is non-active and ready for immediate fog generation and ejection. The vessel pressure is dependent on the fog generating fluid volume which is still available at that moment in the vessel. Typically, a fully filled vessel contains about 70 volume percent fog generating fluid volume and about 30 volume percent compressed propellant gas volume at a pressure of about 110 bars. The electromagnetic valve is closed. The heat exchanger temperature, typically between about 250 and about 400° C., is maintained by an electrical heating element with temperature sensor and power control.

To start the active mode, the valve control receives a start signal, calculates the PWM (Pulse Width Modulation) pattern, i.e. the open-closed ratio, and opens the electromagnetic valve between 5 and 100 percent dependent on the vessel pressure at that moment. The open-closed ratio calculation results in an orifice resistance proportional to the vessel pressure. Accordingly, a high vessel pressure results in a low open-closed ratio and a high orifice resistance. In this way a stable fog generating fluid flow rate, typically between about 10 and 50 milliliter per second, is obtained towards the heat exchanger. A typical PWM pattern has a frequency between 1 and 80 Hz with an open-closed ratio between 0 and 100 percent. The heat exchanger is constructed in order to have a heat exchanging capacity suitable to generate fog for a period of typically about 10 seconds with a fog generating fluid flow rate of about 30 milliliter per second. While the vessel pressure decreases, the valve controller increases the open-closed ratio until all the fog generating fluid is consumed or until the valve controller receives a stop signal and closes the electromagnetic valve.

An operating cycle of a more preferred fog generator in accordance with the present invention may additionally comprise a dynamic back loop from a fog temperature sensor to the valve controller. The open-closed ratio of the valve in active mode is then calculated as a function of current vessel pressure and the expelling fog temperature. The orifice resistance is made proportional to the vessel pressure and reverse proportional to the expelling fog temperature. This creates the possibility to dynamically control the fog generating fluid flow rate in such a way that the momentary heat exchanger heating capacity is used in an optimal way, aiming to generate as much fog volume as possible per time unit.

1. A fog generator comprising a vessel that contains a fog generating fluid and a compressed propellant gas for driving the fog generating fluid from the vessel into a heat exchanger which transforms the fog generating fluid into steam and is connected with the vessel, and a valve positioned between the vessel and the heat exchanger, characterized in that the valve is adapted for controlling the fog generating fluid flow rate by varying its orifice resistance as a function of vessel pressure, such that the fluid flow rate is independent of vessel pressure.

2. A fog generator according to claim 1, further comprising means for determining the vessel pressure.

3. A fog generator according to claim 2, wherein the means for determining the pressure comprises a pressure sensor for measuring the vessel pressure.

4. A fog generator according to claim 2, wherein the means for determining the pressure comprises a memory for storing calculated pressure values.

5. A fog generator according to claims 1 to 4, wherein the valve is further adapted for controlling the fog generating fluid flow rate as a function of expelling fog temperature.

6. A fog generator according to claim 5, further comprising a means for measuring the expelling fog temperature.

7. A fog generator according to any of the above claims, wherein the compressed propellant gas is an inert gas, such as but not limited to nitrogen, or a noble gas, such as but not limited to argon, or a mixture thereof.

8. A fog generator according to any of the above claims, wherein the valve is an electromagnetic valve, a disc valve, or a ball valve.

9. A fog generator according to claim any of the above claims, wherein the fog generating fluid comprises about 10 volume percent of water, about 10 volume percent of triethylene glycol, and about 80 volume percent of dipropylene glycol.
